(19) United States
(12) Patent Application Publication
(10) Pub. No.: US 2012/0119938 A1
(43) Pub. Date: May 17, 2012

(54) FMCW RADAR APPARATUS HAVING PLURALITY OF PROCESSOR CORES USED FOR SIGNAL PROCESSING

(75) Inventors: Yoshihiro Abe, Kariya-shi (JP); Hidetsugu Mishima, Kariya-shi (JP)

(73) Assignee: DENSO CORPORATION, Kariya-city (JP)

(21) Appl. No.: 13/293,428

(22) Filed: Nov. 10, 2011

(30) Foreign Application Priority Data
Nov. 12, 2010 (JP) 2010-253930

(51) Int. Cl. G01S 13/42; G01S 13/58

(52) U.S. Cl. 342/107; 342/109

(57) ABSTRACT

A FMCW radar apparatus obtaining information about a target object includes: a transmitter generating a transmission signal of which frequency is modulated based on the FMCW method, the receiver receiving the radar waves reflected at the object, a mixer that generates a beat signal from a mixed signal of the received signal and the transmission signal, and a signal processing unit processing the beat signal to obtain the information including a distance between the own vehicle and the target object, and a relative velocity of the target object. The signal processing unit includes first calculating means and second calculating means, which operate in parallel each other to calculate the information about the object based on the beat signal from an upward-modulation period when the frequency is modulated to be increased and from a downward-modulation period when the frequency is modulated to be decreased respectively.

### CROSS REFERENCE TO RELATED APPLICATION

This application is based on and claims the benefit of priority from earlier Japanese Patent Application No. 2010-253930 filed Nov. 12, 2010, the description of which is incorporated herein by reference.

### TECHNICAL BACKGROUND

1. Technical Field

The present invention relates to a radar apparatus, and more particularly to a FMCW (Frequency Modulated Continuous Wave) radar apparatus used for preventing a collision against obstacle. The FMCW radar apparatus transmits and receives frequency-modulated radar waves to detect relative distance or relative velocity between an object and the apparatus.

2. Description of the Related Art

Conventionally, a radar apparatus has been employed as a safety device mounted on a vehicle for preventing a collision. For example, a Japanese Patent No. 3804253 discloses a radar apparatus mounted on a vehicle by using a FMCW (Frequency Modulated Continuous Wave) method capable of simultaneously detecting the relative distance between an object (e.g. preceding vehicle) and the own vehicle, and the relative velocity between the object and the own vehicle (hereinafter referred to FMCW radar apparatus). Since the FMCW method can be simply implemented to the radar apparatus, the FMCW radar apparatus is suitable for its downsizing and saving manufacturing cost.

In a conventional FMCW radar apparatus, as shown in FIG. 6A, a solid line indicates a transmission signal Ss of which frequency is modulated by triangle-shape modulation signal such that the frequency is increasing and decreasing linearly with time. The transmission signal Ss is transmitted as radar waves and radar waves reflected at a target object are received by the radar apparatus. As shown by the dotted line in FIG. 6A, the received signal Sr is delayed from the transmission signal by the period required for the radar waves to travel between the target object and the apparatus. Specifically, the received signal is delayed by a delay time Td depending on the distance to the object and the frequency of the received signal is shifted by Fd as an amount of the Doppler shift depending on the relative velocity between the radar apparatus and the target object.

The received signal Sr and the transmission signal Ss are mixed by the mixer so as to generate the beat signal Sb (as shown in FIG. 6B) which is frequency component of the difference between the received signal and the transmission signal. Then, the FFT (Fast Fourier Transformation) conversion process is performed with the digital data of the beat signal Sb whereby the power spectrum is obtained.

Subsequently, by using the obtained power spectrum, the frequency of the beat signal Sb when the frequency of the transmission signal Ss is increasing (i.e., upward-modulated beat frequency fu), and the frequency of the beat signal Sb when the frequency of the transmission signal Ss is decreasing (i.e., downward-modulated beat frequency fd) are extracted. Then, distance R between the target object and the radar apparatus, and the relative velocity V between the object and the radar apparatus are calculated based on the following equations (A1) and (A2):

R={c·T/8·ΔF}·(fu+fd) (A1)

V={c/4Fo}·(fu−fd) (A2)

where c is velocity of the electromagnetic waves, T is the period of the triangle waves that modulate the transmission signal, ΔF is a range of frequency modulation for the transmission signal and Fo is center frequency of the transmission signal.

According to the FMCW radar apparatuses, information including the distance between the own vehicle and the target object has been obtained by processing, e.g. processing as shown in FIG. 7. Specifically, Japanese Patent Application publication Laid-Open Nos. 1997-222474 and 2000-147102 disclose FMCW radar apparatuses in which processing such as processing for obtaining the upward-modulated beat frequency, processing for obtaining the downward-modulated beat frequency, FFT conversion in upward modulation period, FFT conversion in downward modulation period, a direction estimating processing in the upward modulation, direction estimating processing in the downward modulation and object recognition processing for an object (vehicle) are performed sequentially.

However, according to the above-described related art, for instance, as shown in FIG. 7, a single microprocessor sequentially executes the processing. In this case, this processing requires high load operation of the microprocessor. Therefore, the calculation period for recognizing the objects in the FMCW radar apparatus cannot be shortened so that the response characteristics to detect objects such as vehicles cannot be improved.

### SUMMARY

An embodiment provides a FMCW radar apparatus in which necessary period for calculating the information about the target object can be shortened and the response time for detecting the target object can be shortened as well.

As a first aspect of the embodiment, a FMCW radar apparatus mounted on an own vehicle is provided. The apparatus obtains information about a target object. The information includes a distance between the own vehicle and the target object and a relative velocity of the target object. The FMCW radar apparatus includes: a transceiver including a transmitter and a receiver, the transmitter generating a transmission signal of which frequency is modulated with time to increase and decrease the frequency thereby transmitting the transmission signal as radar waves, the receiver receiving the radar waves reflected at the target object; a mixer mixing the received signal and the transmission signal as a local signal so as to generate a beat signal including a frequency component representing a frequency difference between the received signal and the local signal; and a signal processing unit processing the beat signal to obtain the information including a distance between the own vehicle and the target object, and a relative velocity of the target object. The signal processing unit includes first calculating means for calculating the information about the target object based on the beat signal from an upward-modulation period when the frequency is modulated to be increased and second calculating means for calculating the information about the target object based on the beat signal from a downward-modulation period when the frequency is modulated to be decreased. Especially, the first calculating means and the second calculating means are adapted to operate in parallel each other. The calculation of the information about the target object includes FFT (Fast Fourier Transformation) processing and processing for estimating the direction of the target object.

According to the embodiment, when the beat signal in upward-modulation is obtained, the first calculating means performs a calculation by using the upward-modulation beat signal at once. When the beat signal in downward-modulation is obtained, the second calculating means performs a calculation by using the downward-modulation beat signal at once (in parallel with the calculation by the first calculating means). Hence, according to the embodiment, when the necessary signal for calculation is obtained, the respective calculating means can immediately perform the calculation. As a result, unlike the conventional radar apparatuses, to start the second calculating means, it is not necessary to wait until completion of the calculation by the first calculating means.

Therefore, comparing with the conventional radar apparatuses, according to the embodiment, a calculating period for detecting the target object in the FMCW radar apparatus can be shortened so that the response time to detect the target object such as a vehicle can be shortened.

As a second aspect of the embodiment, the signal processing unit can obtain other information about the target object such that after completion of the calculation by the first calculating means and second calculating means, the first calculating means or the second calculating means further calculates other information about the target object by using calculation results of the first and second calculation means.

As a third aspect of the embodiment, the signal processing unit processes the beat signal from the upward-modulation period and the beat signal from the downward-modulation period whereby the signal processing unit performs direction estimating processing to obtain the information about a direction of the target object relative to the own vehicle where the radar apparatus is mounted. Therefore, the signal processing unit can obtain information about the direction of the target object other than the information about the distance or the relative velocity information.

As a fourth aspect of the embodiment, the signal processing unit employs two processor cores as the first calculating means and the second calculating means which are arranged in a single microprocessor. Each core serves as a single processor core including an instruction unit, an arithmetic and logic unit and so forth which are combined together. In a multiprocessor package accommodating a plurality of processor cores, each processor core can operate individually without any influence each other.

As a fifth aspect of the embodiment, the first calculating means and second calculating means are configured by different microprocessors. A single chip microprocessor can be implemented to this configuration as the microprocessor.

As a sixth aspect of the embodiment, the target object is a vehicle.

### BRIEF DESCRIPTION OF THE DRAWINGS

In the accompanying drawings:

FIG. 1 is a block diagram showing an overall configuration of a FMCW radar apparatus according to the first embodiment of the present invention;

FIG. 2 is an explanatory diagram showing a difference between a single core processing and a double core processing;

FIG. 3 is an explanatory diagram showing a memory map of a RAM (random access memory) in which upward-modulated data and downward-modulated data are stored in different memory regions;

FIG. 4 is a flowchart showing a procedure executed in the FMCW radar apparatus according to the first embodiment;

FIG. 5 is a block diagram showing an overall configuration of the FMCW radar apparatus according to the second embodiment;

FIGS. 6A and 6B are an explanatory diagrams each showing principle of the FMCW radar apparatus; and

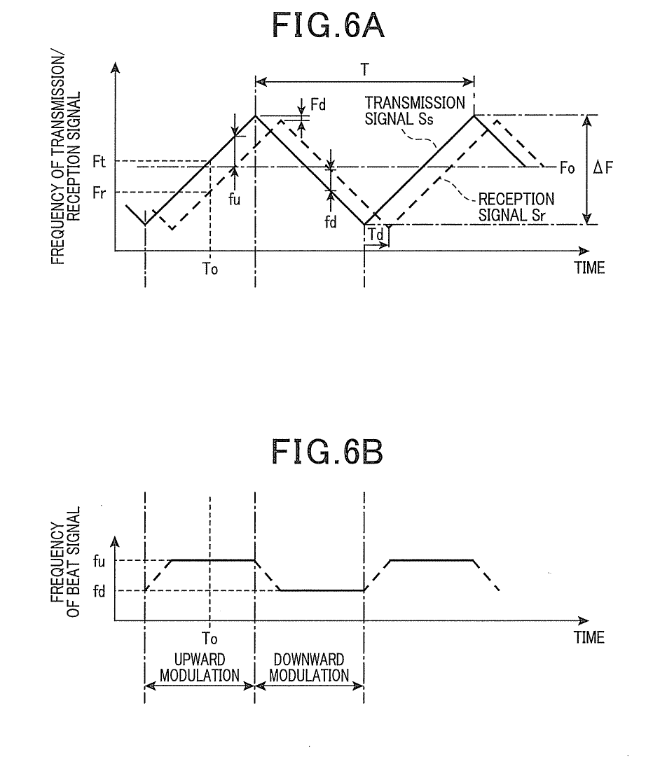

FIG. 7 is an explanatory diagram showing an example procedure executed in a conventional FMCW radar apparatus.

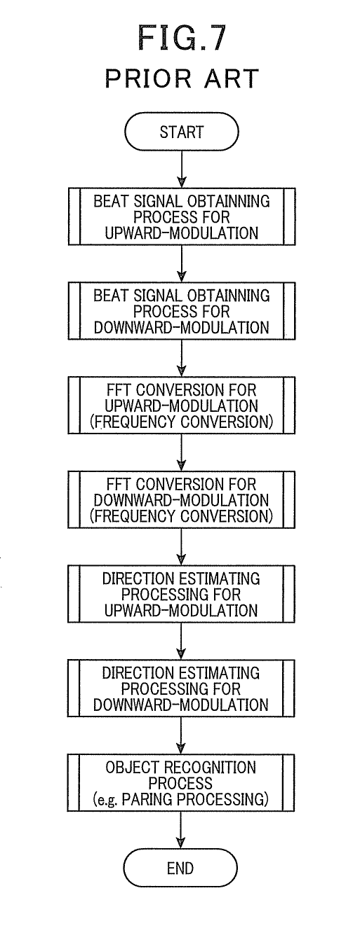

### DETAILED DESCRIPTION OF THE PREFERRED EMBODIMENTS

Hereinafter will be described an on-vehicle FMCW radar apparatus used for an object recognition apparatus mounted on an own vehicle. The object recognition apparatus detects objects present in front of the own vehicle such as preceding vehicles.

### First Embodiment

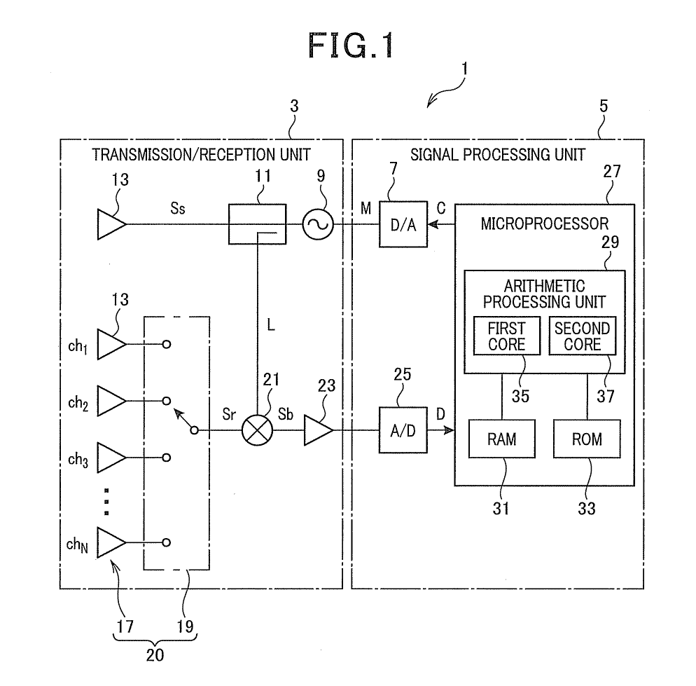

With reference to FIGS. 1 to 4, herein after is described a first embodiment. An overall configuration of the FMCW radar apparatus according to the first embodiment (hereinafter is called as radar apparatus) is described. As shown in FIG. 1, a radar apparatus 1 according to the first embodiment is an apparatus capable of detecting a distance between the target object and the own vehicle, a relative velocity between the target object and the own vehicle, and a direction of the target object relative to the own vehicle. The radar apparatus 1 includes a transmission/reception device 3 that transmits and receives radar waves, a signal processing unit 5 that controls the radar, apparatus 1 and to process various calculations in order to detect target objects.

Specifically, the radar apparatus 1 is provided with D/A (digital to analog) converter 7 that generates triangle-shape modulation signal M in response to a modulation command C, a voltage controlled oscillator (VCO) 9 that changes an oscillation frequency of the VCO 9 in response to the modulation signal M generated by the D/A converter 7, a distributor 11 that distributes the output signal of the VCO 9 into a transmission signal Ss and a local signal L, and a transmission antenna 13 that emits the radar waves in response to the transmission signal Ss. The triangle-shape modulation signal is used to modulate the frequency of the transmission signal to be increased or decreased linearly with time.

Moreover, the radar apparatus 1 includes a reception antenna unit 17, a reception switch 19, a mixer 21, an amplifier 23 and an A/D converter 25. The reception antenna has a plurality of reception antenna 15 that receives radar waves. The reception switch 19 selects a signal from the respective antenna 15 and supplies the selected signal to the subsequent units. The mixer 21 mixes the received signal Sr supplied by the reception switch 19 with the local signal L thereby generating the beat signal Sb. The amplifier 23 amplifies the beat signal Sb generated by the mixer 21. The A/D converter 25 samples the beat signal Sb amplified by the amplifier 23 and converts the sampled signal into the digital data D.

The reception antenna unit 17 is an adaptive antenna in which N (N is an integer number two or more) number of reception antennas 15 are arrayed with the same intervals each other. The received signals Sr (=xi (t), (i=1 to N)) of the incoming waves received by the reception antennas 15 are transmitted to the mixer 21 via the reception switch 19. It is noted that the reception antenna unit 17 and the reception switch 19 constitute the reception unit 20.

The mixer 21 mixes the received signal Sr and the local signal L so as to generate the beat signal Sb which is a frequency component of the difference between these signals. It is noted that the frequency component of the beat signal Sb is called the beat frequency. As described above, among the beat frequencies, a beat frequency detected during an increase-period of the frequency of the transmission signal Ss is called the upward-modulated beat frequency fu, and a beat frequency detected during a decrease-period of the frequency of the transmission signal Ss is called the downward-modulated beat frequency fd. These beat frequencies fu and fd are used for calculating the distance and the relative velocity between the own vehicle and the target object by FMCW method.

The signal processing unit 5 includes a well-known microprocessor 27 which includes an arithmetic processing unit 29 for processing various calculations and RAM (SRAM: static RAM) 31 and ROM 33.

Particularly, according to the embodiment, the arithmetic processing unit 29 includes processor cores, i.e., a first core 35 (first calculating means) and a second core 37 (second calculating means), which are capable of executing various operations in parallel. The microprocessor 27 performs estimation (calculation) of the direction in MUSIC (Multiple Signal Classification) method (described later) based on the beat signal (digital data D) which has been converted into the digital data by the A/D converter 25, and calculates the distance and the relative velocity based on the FMCW method.

As described later, in the microprocessor 27, both the first core 35 and the second core 37 execute the FFT (Fast Fourier Transformation) processing for the digital data D acquired by the A/D converter 25, and estimates the direction where the object reflecting the radar waves is present. Moreover, both cores 35 and 37 executes processing such as calculation of the distance between the own vehicle and the object, and the relative velocity between the own vehicle and the object.

Next, major processing portion executed by the radar apparatus 1 according to the embodiment is described as follows. In this processing, an example is explained where each of the upward-modulation period and the downward-modulation period is executed twice.

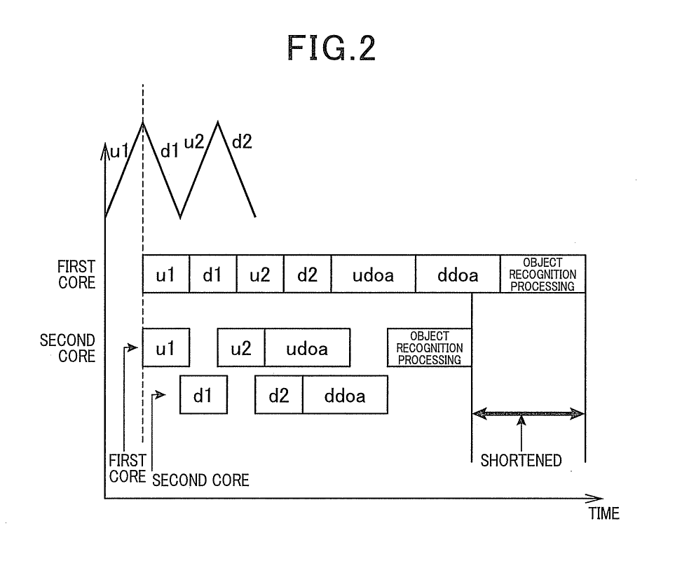

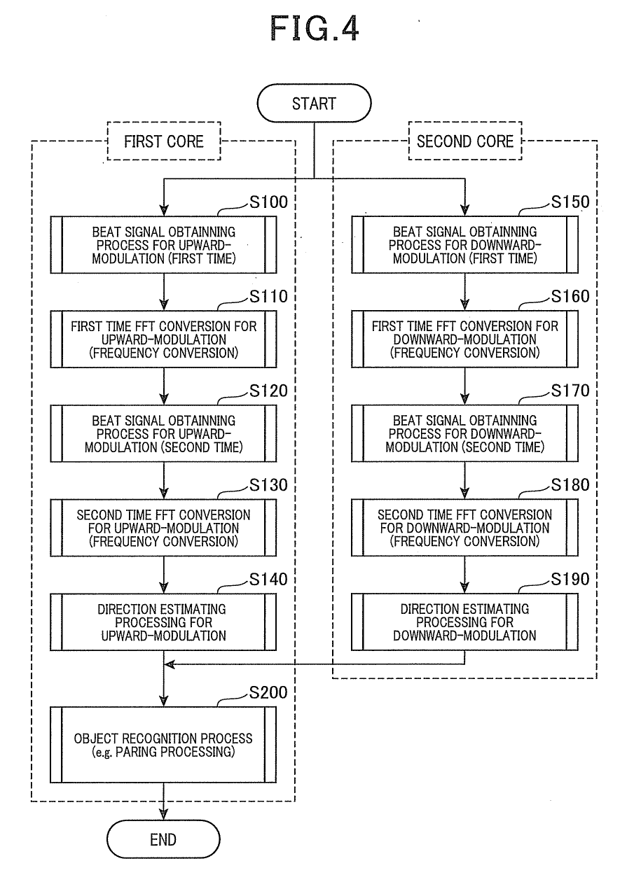

As shown in FIG. 2 (refer to second core), according to the embodiment, the processing to detect the target object is executed by the first core 35 and the second core 37 in parallel processing. Specifically, when a section of the first upward-modulation period (upward section) is completed, the first core 35 processes a first upward signal processing (u1) by using the received data Ss obtained at the first upward-modulation period. The first upward signal processing (u1) includes a processing for obtaining a beat signal and the FFT conversion processing when the first upward-modulation is performed, which is described later (see FIG. 4).

Subsequently, when the second upward-modulation is completed, the first core 35 executes a second upward signal processing (u2) by using data of the received signal Ss obtained at the second upward-modulation period. Similarly, the second upward signal processing (u2) includes a processing for obtaining the beat signal and the FFT conversion processing when the second upward-modulation period is performed.

Next, the first core 35 performs a direction estimating processing (udoa) by using the result of the first upward signal processing (u1) and the result of the second upward signal processing (u2). Meanwhile, the second core 37 performs a processing in parallel to the first core 35. In more detail, the second core 37 executes a first downward signal processing (d1) by using data of the received signal Ss at the first downward-modulation period when the first downward-modulation (downward section) is completed. The first downward signal processing (d1) includes a processing for obtaining the beat signal and the FFT conversion processing when the first downward-modulation is performed (described later).

The second core 37 executes the second downward signal processing (d2) by using data of the received signal Ss at the second downward-modulation period when the second downward-modulation is completed. Similarly, the second downward signal processing (d2) includes a processing for obtaining the beat signal and the FFT conversion processing when the second downward-modulation is performed.

Subsequently, the second core 37 performs a direction estimating processing (ddoa) by using the result of the first downward signal processing (d1) and the result of the second downward signal processing (d2). Then, when the direction estimating processing (ddoa) is completed by the second core 37, the first core 35 performs an object recognition process such as paring, a detection of the distance and the relative velocity between the target object and the own vehicle by using the calculation result of the both cores 35 and 37 (described later). The direction estimating processing (udoa and ddoa) estimates the direction of the object relative to the own vehicle.

Therefore, comparing with conventional processing such as an object recognition process sequentially performed by the single core (i.e., u1->d1->u2->d2->udoa->ddoa), calculation period for detecting the target object can be shortened (described later in more detail).

As described, the signal processing is performed multiple times (two times), that is, the upward signal process (u1, u2) and the downward signal processing (d1, d2). However, the signal processing can be performed one time by each processing, that is, each of the upward signal processing (u1) and the downward signal processing (d1) is performed once in the signal processing.

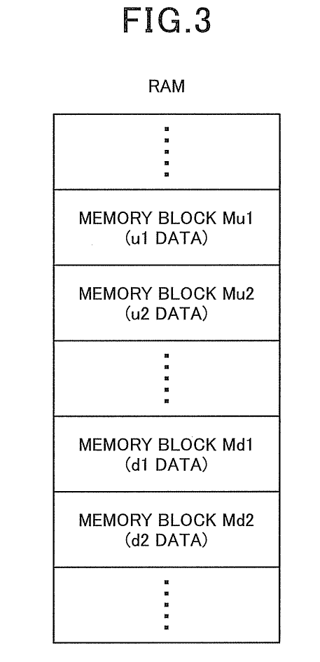

c) Next, a processing executed in the radar apparatus 1 according to the embodiment is described in more detail as follows. Regarding method of storing data of the signal received by the radar apparatus 1, hereinafter is described with reference to FIG. 3.

As shown in FIG. 3. the beat signal Sb obtained by the transmission/reception device 3 is sampled at a predetermined frequency (e.g. 200 KHz) by the A/D converter 25 at the respective modulations. The sampling is performed for the beat signals of the upward-modulation period and the downward-modulation period. Then the sampled beat signals are sequentially stored into the RAM 31.

Specifically, the sampled data used for the first upward signal processing (u1), i.e., the digital data corresponding to the first upward section (u1 data) is stored to a predetermined memory block Mu1 of the RAM 31. In other word, the sampled data is stored sequentially in time into a predetermined address area corresponding to the memory block Mu1.

Further, the sampled data used for the second upward signal processing (u2), i.e., the digital data corresponding to the second upward section (u2 data) is stored to a predetermined memory block Mu2 of the RAM 31. In other word, the sampled data is stored sequentially in time into a predetermined address area corresponding to the memory block Mu2.

Similarly, the sampled data used for the first downward signal processing (d1), i.e., the digital data corresponding to the first downward section (d1 data) is stored to a predetermined memory block Md1 of the RAM 31. In other word, the sampled data is stored sequentially in time into a predetermined address area corresponding to the memory block Md1.

Further, the sampled data used for the second downward signal processing (d2), i.e., the digital data corresponding to the second downward section (d2 data) is stored to a predetermined memory block Md2 of the RAM 31. In other word, the sampled data is stored sequentially in time into a predetermined address area corresponding to the memory block Md2.

The processing recognizes which processing among u1, u2, d1 and d2 to be used for the sampled data based on the output timing of the modulation command C. In other word, the processing determines which address area of the memory block is used for the sampled data based on the output timing of the modulation command C.

Specifically, the timing when the signal is transmitted by the transmission antenna 13 is determined by the output timing of the modulation command C which is outputted by the microprocessor 27. Hence, the reception timing of the digital data D (i.e., sampled data stored to the RAM 31) where the A/D converter 25 is input to the microprocessor 27 is decided in response to the output timing of the modulation command C. As a result, based on the reception timing of the digital data D, the processing determines the address area corresponding to the memory block where the received sampled data is to be stored. Thus, since the reception timing is matched with the stored address area in advance, the stored address area can be determined.

Next, with reference to FIG. 4, contents of the processing executed by both cores 35 and 37 is explained as follows.

In FIG. 4, the same flowchart is applied for the calculations executed by the both core 35 and 37 to illustrate both calculations are executed in parallel. As shown in FIG. 4, at step 100, the first core 35 starts to execute a processing for obtaining the upward-modulated beat frequency (beat signal obtaining process for upward-modulation) as a first time when the first-time upward-modulation is completed.

The microprocessor 27 acquires sampled data at the first-time upward-modulation period (u1 data) stored in the memory block Mu1 of the RAM31. Subsequently, at step 110, well-known FFT processing (Fast Fourier Transformation) is performed by using the sampled data (u1 data) whereby the beat frequency is obtained. In other word, the power spectrum Pu1 at the first-time upward-modulation is obtained. It is noted that the beat frequency fu at the upward-modulation period, i.e., upward beat frequency fu1 calculated based on the u1 data, is obtained from the power spectrum Pu1.

The steps 100 and 101 correspond to the processing of u1. At step 120, the microprocessor 27 starts to execute a processing for obtaining the upward-modulated beat frequency as a second time when the second-time upward-modulation is completed.

Specifically, the microprocessor 27 obtains the sampling data (us data) at the second-time upward-modulation period from the memory block Mu2 of the RAM 31. At step 130, the FFT processing is performed by using the sampled data (u2 data) so as to obtain the beat frequency. That is, power spectrum at the second-time upward-modulation period, i.e., Pu2 is calculated.

The steps 120 and 130 correspond to the processing of u2. Next at step 140, well-known direction estimating processing is performed with the power spectrum Pu1 obtained by the FFT processing at step 140 and the power spectrum Pu2 obtained by the FFT processing at step 130.

Regarding the direction estimating processing, a well-known method in order to estimate direction of the incoming electromagnetic waves can be applied. For instance, the MUSIC (Multiple Signal Classification) method or ESPRIT (Estimation of Signal Parameters via Rotational Invariance Techniques) method can be applied to the direction estimating processing. In the MUSIC method, an angular spectrum is calculated based on a correlation matrix indicating a correlation between the received signals received by the respective antenna elements (e.g. channel), then the calculated angular spectrum is scanned whereby the direction can be estimated with high resolution.

As an example, hereinafter is briefly described a MUSIC method disclosed in a Japanese patent application laid-open number 2008-185471. It is noted that an array antenna is used as a linear array antenna in which N number (N is two or more integer number) of antenna elements are disposed linearly with constant interval.

First, based on the power spectrum Pu1 obtained by the FFT processing at step 110 and the power spectrum Pu2 obtained by the FFT processing at step 130, the microprocessor 27 performs the MUSIC method for extracted frequency assuming the signal component based on reflected waves at the object is present.

Then, the microprocessor extracts selected signal components representing the frequency (FFT processing data) from the power spectrums of the all channel (Ch1 to Ch N) and arrange the signal components so as to generate a reception vector X (i). Subsequently, by using the reception vector X(k) defined by the following equation (1), the processing acquires the correlation matrix Rxx having N rows and N columns according to the following equation (2).

Note: T represents the transpose of a vector, and H represents the complex conjugate transpose.

X(k)={x₁(k),x₂(k), . . . ,x_{N}(k)}^{T} (1)

Rxx=X(k)X^{H}(k) (2)

Next, eigenvalues λ1 to λN (where λ1≧λ2≧ . . . ≧ . . . ≧λN) of the correlation matrix Rxx are calculated thereby estimating the number of incoming waves L (<N), i.e., the number of reflections, from the number of eigenvalues larger than a threshold value of noise TH (equal to the power of thermal noise σ2, hereinafter referred to noise threshold TH). As a result, eigenvectors e1 to eN correspond to the eigenvalues λ1 to λN are calculated.

Subsequently, noise eigenvectors EN0 having eigenvectors corresponding to (N-L) number of eigenvalues which are less than the noise threshold TH are defined as the following equation (3). The microprocessor 27 calculates an evaluation function PMU (θ) represented as the following equation (4), where a complex response of the array antenna in terms of the direction θ represents a (θ).

$$\begin{matrix}{E}_{N 0} = \{ {e}_{L + 1} , {e}_{L + 2} , … , {e}_{N} \} & ( 3 ) \\ {P}_{MU} ( θ ) = \frac{{a}^{H} ( θ ) a ( θ )}{{a}^{H} ( θ ) {E}_{NO} {E}_{NO}^{H} a ( θ )} & ( 4 )\end{matrix}$$

The angular spectrum (MUSIC spectrum) obtained from the evaluation function PMU (θ) diverges when θ corresponds to the incoming direction of the incoming waves to have sharp peak. Therefore, estimated values θ1 to θL of the incoming direction can be obtained by searching the peak of the MUSIC spectrum (i.e., null point).

In other word, incoming direction of the reflected waves of the radar waves, i.e., the direction of the target object can be estimated by the above-described well-known direction estimating processing. The first core 35 first executes the above-described procedures of steps 100 to 140.

Meanwhile, in the second core 37, similar processing to the steps 100 to 140 executed at the first core 35 (note: order of the processing i.e., direction of modulations upward or downward is different) are executed. Therefore, the explanation of the processing executed in the second core 37 is briefly described as follows.

As shown in FIG. 4, the second core 37 starts to execute the first-time processing for obtaining the beat signal, i.e., beat signal obtaining process for downward-modulation (S150) when the first-time downward-modulation is completed.

Specifically, the microprocessor 27 acquires the sampling data at the first-time downward-modulation (d1 data) from the memory block Md1 of the RAM 31. Next at step 160, the well-known FFT processing (Fast Fourier Transformation) is performed by using the sampled data (d1 data) so that the beat frequency is obtained. In other word, the power spectrum Pd1 at the first-time downward-modulation period is calculated.

The processing of steps 150 and 160 correspond to the processing for d1. At step 170, the microprocessor 27 starts to execute the processing for obtaining the beat frequency at the second-time downward-modulation when the second-time downward-modulation is completed.

The microprocessor 27 acquires the sampled data at the second-time downward-modulation (d2 data) from the memory block Md2 of the RAM 31. Next at step 180, the FFT processing is performed by using the sampled data (d2 data) so as to obtain the beat frequency. In other word, the power spectrum Pd2 at the second-time downward-modulation period is calculated.

The processing of steps 170 and 180 correspond to the processing for d2. At next step 190, well-known direction estimating processing such as above-described MUSIC method is performed with the power spectrum Pd1 obtained by the FFT processing at step 160 and the power spectrum Pd2 obtained by the FFT processing at step 180.

As a result, performing the above-described direction estimating processing, the direction of the target object (incoming direction of the reflected radar waves) can be estimated from the power spectrum in the downward-modulation period. In the second core 37, the processing steps 150 to 190 are executed first.

Subsequently, when the processing of steps 150 to 190 are completed at the second core 37, the second core 37 notifies the completion of the processing to the first core 35 and transmits the result of the processing to the first core 35. Then, the first core 35 performs the well-known object recognition processing by using the result of the processing at steps 100 to 140 executed by the first core 35 and the result of the processing at steps 150 to 190 executed by the second core 37.

Specifically, in the object recognition processing, a pairing processing is executed first. In the pairing processing, peak frequencies indicating the same direction in the upward-modulation and the downward-modulation are combined as a peak pair.

Then, the microprocessor 27 performs a calculation to obtain the distance and the relative velocity between the target object and the own vehicle from the peak pair by using the well-known method used for the FMCW radar, and terminates the calculation after outputting the distance and the relative velocity as target information.

As described above, when calculating the distance and the relative velocity, respective power spectrums at both upward and the downward modulations are employed. However, when respective number of power spectrums at the upward-modulation and the downward modulation are two or more, an averaged power spectrum, i.e., a plurality of power spectrums averaged at the upward-modulation period and a plurality of power spectrums averaged at the downward-modulation period can be employed.

As described above, according to the radar apparatus 1, the first core 35 and the second core 37 are used such that the first core 35 performs the FFT processing immediately after the reception data at the upward-modulation (upward beat signal) is obtained and the second core 37 performs the FFT processing in parallel with the processing executed by the first core 35, immediately after the reception data at the downward-modulation (downward beat signal) is obtained.

According to the embodiment, when necessary signals are obtained, the respective cores 35 and 37 can immediately start processing. Hence, unlike the related art, the microprocessor 27 no longer waits until necessary signal will be obtained to start processing.

As a result, comparing with the related art, even if the load of the respective processing (e.g. processing load of the FFT) is high, a processing period to detect the target object in the radar apparatus 1 can be shortened thereby significantly improving the response of detecting the target objects such as vehicles.

### Second Embodiment

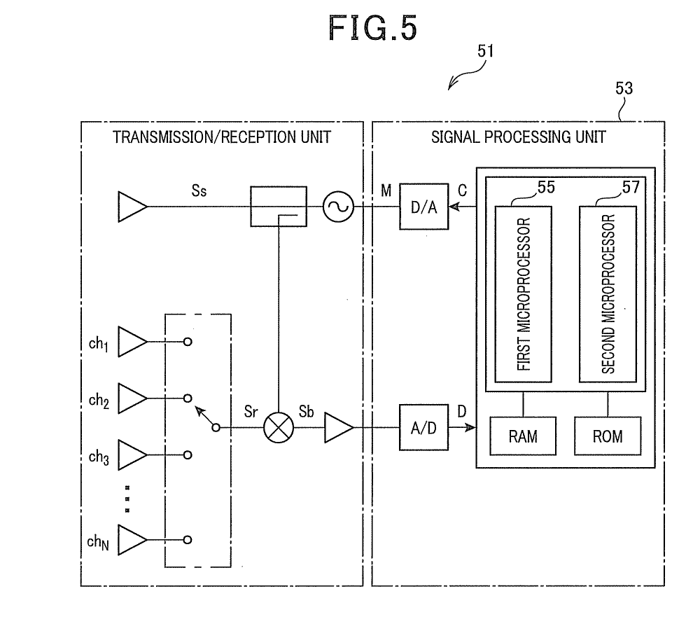

With reference to FIG. 5, hereinafter will be described the second embodiment. The contents similar to those in the first embodiment are omitted in the second embodiment. According to the second embodiment, unlike the radar apparatus of the first embodiment in which a multi core (e.g. dual core) is disposed in the single microprocessor (one-chip microprocessor), as shown in FIG. 5, a plurality of microprocessors (one-chip microprocessor) 55 and 57 (e.g. two microprocessors) are arranged in the signal processing unit 53 of the radar apparatus 51.

In the first microprocessor 55, as similar to the first core, the FFT processing is performed immediately after the reception data at the upward-modulation (upward beat signal) is obtained. In the second microprocessor 57, the FFT processing is performed in parallel to the processing executed at the microprocessor 55 immediately after the reception data at the downward-modulation (downward beat signal) is obtained.

Accordingly, similar to the first embodiment, unlike the related art described in the Related Art section, the microprocessor can perform the processing without waiting the beat signals obtained for both upward and downward directions whereby processing period necessary for detecting the target object in the radar apparatus 51 can be shortened even when the load of the respective processing (e.g. processing load of the FFT) is high. As a result, the response time to detect the target objects such as preceding vehicles can be shortened.

As described, embodiments according to the present invention are exemplified. The present invention is not limited to the aforementioned embodiments, however, various modifications can be made in the scope of the present invention. For example, the present invention is not limited to apparatuses in the own vehicle for obtaining the distance and the relative velocity between the own vehicle and the preceding vehicle, however, the present invention can be applied to apparatuses disposed in aircrafts, ships and trains in order to obtain information about the target objects.

What is claimed is:

1. A FMCW radar apparatus mounted on an own vehicle, obtaining information about a target object, the apparatus comprising:
a transceiver including a transmitter and a receiver, the transmitter generating a transmission signal of which frequency is modulated with time to increase and decrease the frequency thereby transmitting the transmission signal as radar waves, the receiver receiving the radar waves reflected at the target object;
a mixer mixing the received signal and the transmission signal as a local signal so as to generate a beat signal including a frequency component representing a frequency difference between the received signal and the local signal; and
a signal processing unit processing the beat signal to obtain the information including a distance between the own vehicle and the target object, and a relative velocity of the target object, wherein
the signal processing unit includes first calculating means for calculating the information about the target object based on the beat signal from an upward-modulation period when the frequency is modulated to be increased and second calculating means for calculating the information about the target object based on the beat signal from a downward-modulation period when the frequency is modulated to be decreased, and the first calculating means and the second calculating means are adapted to operate in parallel with each other.

2. The apparatus according to claim 1, wherein the signal processing unit obtains other information about the target object such that after completion of the calculation by the first calculating means and second calculating means, the first calculating means or the second calculating means further calculates other information about the target object by using calculation results of the first and second calculation means.

3. The apparatus according to claim 2, wherein the signal processing unit processes the beat signal from the upward-modulation period and the beat signal from the downward-modulation period whereby the signal processing unit performs a direction estimating processing to obtain the information about a direction of the target object relative to the own vehicle where the radar apparatus is mounted.

4. The apparatus according to claim 1, wherein the first calculating means and the second calculating means are configured by two processor cores disposed in a single microprocessor.

5. The apparatus according to claim 1, wherein the first calculating means and second calculating means are configured by different microprocessors.

6. The apparatus according to claim 1, wherein the target object is a vehicle.
